(19) United States
(12) Patent Application Publication
(10) Pub. No.: US 2007/0009768 A1
(43) Pub. Date: Jan. 11, 2007

(54) Magnetic recording medium and method for manufacturing the same

(75) Inventors: Toshiharu Takeda, Odawara-shi (JP); Katsuhiko Meguro, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/475,068

(22) Filed: Jun. 27, 2006

(30) Foreign Application Priority Data
Jul. 11, 2005 (JP) 2005-201996

(51) Int. Cl. G11B 5/706; G11B 5/708; B05D 5/12

(52) U.S. Cl. 428/842; 428/847.3; 427/127

(57) ABSTRACT

The present invention provides a magnetic recording medium comprising: a non-magnetic substrate; and one or more magnetic layers formed on the non-magnetic substrate, wherein the magnetic recording medium has a loss modulus at 0.5 Hz at a temperature of 130° C. of 0.18 to 0.39 GPa, in order to improve dimensional stability and running stability of a tape, particularly in a high-temperature environment, and thereby improve reliability in recording and reproduction of data, and to provide a method for manufacturing the same. Also, the magnetic recording medium of the present invention attains the object to solve the problem that tension for driving generates nonuniform elongation in the medium, resulting in reduction of running stability because of a thin magnetic recording medium which is reduced the total thickness to increase the capacity of the backup tape per reel by increasing a tape length and increase.

### BACKGROUND OF THE INVENTION

1. Field of the Invention

The present invention relates to a magnetic recording medium and a method for manufacturing the same, particularly to a magnetic recording medium having improved dimensional stability in a high-temperature environment and a method for manufacturing the same.

2. Description of the Related Art

Magnetic tapes which are one type of the magnetic recording media are used not only as cassette tapes and video tapes, but also used as tapes for data backup of computers. In the field of tapes for data backup, there is commercialized a tape having a storage capacity of 100 GB or more per reel with the increase in the capacity of hard disks to be backed up. In order to be ready for further increase in the capacity of hard disks in future, further increase in the capacity of the magnetic tapes for backup is also indispensable.

When the capacity of the magnetic tapes is increased, reliability in recording and reproduction of data is also very important. In particular, it is necessary to accurately record data and accurately reproduce the recorded data even in a severe environment, for example, even after storing in a high-temperature environment.

A proposal has been made that, for example, durability, particularly cycle environmental characteristics, of a magnetic recording medium should be improved in order to address these problems (refer to Japanese Patent Application Laid-Open No. 11-110735).

According to the proposal, a substrate of the magnetic recording medium is subjected to heat treatment for a predetermined period of time at temperatures lower than the glass transition point of the substrate to increase the endotherm based upon enthalpy relaxation of the substrate to a predetermined value or more. Reliability in recorded and reproduced data is said to be improved by employing the proposal.

### SUMMARY OF THE INVENTION

However, there has been a problem unsolved by the prior art as described above. That is, in a severe environment as described above, accurate recording and reproduction of data may be impossible since each member constituting a magnetic recording medium generally deforms due to creep or the like, which causes a dimensional change. The prior art (Japanese Patent Application Laid-Open No. 11-110735 or the like) is insufficient to the problem.

Moreover, in order to increase the capacity of the backup tape per reel, it is also necessary to increase a tape length per reel by reducing the total thickness of the tape. In this case, when a thin magnetic recording medium is recorded and reproduced in a drive, tension for driving generates nonuniform elongation in the medium, resulting in reduction of running stability. Therefore, a solution of this problem has been strongly requested.

The present invention has been made in view of the above situation, and it is an object of the present invention to provide a magnetic recording medium having improved dimensional stability of a tape, particularly in a high-temperature environment and capable of improving reliability in recording and reproduction of data, and to provide a method for manufacturing the same.

In order to achieve the above described object, the present invention provides a magnetic recording medium comprising a non-magnetic substrate and one or more magnetic layers formed on the non-magnetic substrate, the magnetic recording medium having a loss modulus at 0.5 Hz at a temperature of 130° C. of 0.18 to 0.39 GPa.

Further, the present invention provides a magnetic recording medium comprising a non-magnetic substrate and one or more magnetic layers formed on the non-magnetic substrate, wherein the non-magnetic substrate is composed of polyethylene naphthalate and has a loss modulus at 0.5 Hz at a temperature of 130° C. of 0.15 to 0.37 GPa.

According to the present invention, the loss modulus of the magnetic recording medium or the non-magnetic substrate is controlled within the optimum range. This improves the dimensional stability of a tape, and as a result, it is possible to improve reliability in recording and reproduction of data.

That is, the present inventor has focused attention on the non-magnetic substrate among various members which constitute the magnetic recording medium and investigated the form stability of the substrate, and has found that it is possible to obtain a magnetic recording medium which can solve the above problem by subjecting the substrate to a specific heat treatment to specify the loss modulus of the substrate.

The loss modulus refers to an index for evaluating damping properties of a material and corresponds to E₂ when the complex modulus is represented by the formula: E=E₁+iE₂, wherein E₁ is a value which changes reversibly; E₂ is a value which changes irreversibly; and i indicates complex number.

Moreover, the glass transition temperature Tg, which is also called the glass transition point, is based on the phenomenon that when a polymer material is heated, it changes from a glassy rigid state to a rubbery state (glass transition), and refers to the temperature where the glass transition occurs.

In the present invention, the magnetic recording medium preferably further comprises a magnetic or non-magnetic intermediate layer between the non-magnetic substrate and the magnetic layer. Thus, the provision of a non-magnetic intermediate layer further improves the form stability.

Furthermore, the present invention provides a method for manufacturing a magnetic recording medium comprising forming one or more magnetic layers and/or non-magnetic layers on a non-magnetic substrate, wherein the non-magnetic substrate is subjected to heat treatment at temperatures 1 to 25° C. lower than the glass transition temperature Tg of the substrate before forming the magnetic layers and/or the non-magnetic layers; and the heat treatment temperatures for the substrate in a manufacturing step after the heat treatment are maintained at temperatures lower than the glass transition temperature Tg of the substrate.

According to the present invention, the non-magnetic substrate is subjected to heat treatment at temperatures 1 to 25° C. lower than the glass transition temperature Tg before forming the magnetic layers and/or the non-magnetic layers, and heat treatment temperatures to be applied to the substrate in the manufacturing step after the heat treatment are kept at temperatures less than the glass transition temperature. This improves dimensional stability of a tape, and as a result, it is possible to improve reliability in recording and reproduction of data.

As described above, the present invention improves dimensional stability of a tape, and as a result, it is possible to improve reliability in recording and reproduction of data.

### BRIEF DESCRIPTION OF THE DRAWINGS

FIG. 1 is a partially enlarged sectional view illustrating a layer structure of a magnetic recording medium according to the present invention; and

FIG. 2 is a table showing evaluation results of examples and comparative examples.

### DETAILED DESCRIPTION OF THE PREFERRED EMBODIMENTS

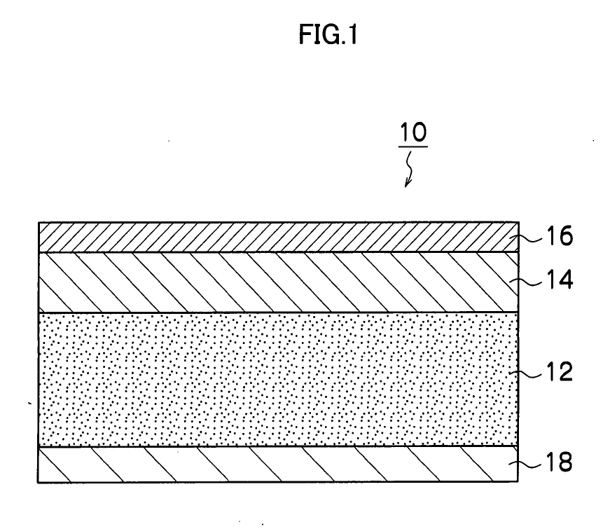

Embodiments of the present invention will now be described, referring to appended drawings. FIG. 1 is a partially enlarged sectional view illustrating a layer structure of a magnetic recording medium according to the present invention.

As shown in FIG. 1, in a magnetic recording medium 10 of the present invention, a non-magnetic intermediate layer 14 is formed on the front side of a non-magnetic flexible substrate 12, and a magnetic layer 16 is formed on the intermediate layer 14. In addition, a back coat layer 18 is formed on the back side of the non-magnetic flexible substrate 12.

An undercoat layer for improving adhesion may be provided between the non-magnetic flexible substrate 12 and the intermediate layer 14 or between the intermediate layer 14 and the magnetic layer 16. When the undercoat layer is provided, the layer preferably has a thickness of 0.01 to 0.5 μm, more preferably 0.02 to 0.5 μm.

The thickness of the substrate is not limited, but is preferably 2 to 100 μm, more preferably 2 to 80 μm. The non-magnetic substrate for computer tapes typically has a thickness in the range of 3.0 to 10 μm (preferably 3.0 to 9.0 μm, and more preferably 3.0 to 8.0 μm).

In the magnetic recording medium of the present invention, the magnetic layer preferably has an average thickness of 40 to 200 nm, more preferably 50 to 200 nm. The magnetic layer 16 may achieve the object of the present invention whether it is composed of a single layer or a plurality of layers.

The intermediate layer which underlies the magnetic layer in the magnetic recording medium of the present invention has a thickness of generally 0.05 to 5.0 μm, preferably 0.1 to 3.0 μm, and more preferably 0.1 to 2.5 μm. The back coat layer 18 preferably has a thickness of 0.2 to 1.5 μm, more preferably 0.3 to 0.8 μm.

The structure of each layer of the magnetic recording medium 10 and a method for manufacturing the magnetic recording medium 10 will now be described for each item below.

(Substrate)

Examples of the non-magnetic flexible substrate 12 for use in the present invention include known films made from polyesters such as polyethyleneterephthalate and polyethylene naphthalate, polyolefins, cellulosetriacetate, polycarbonate, polyamide, polyimide, polyamideimide, polysulfone, aramid, and aromatic polyamide. These substrates may be subjected, in advance, to corona discharge treatment, plasma treatment, treatment for easy adhesion, heat treatment, dust-removing treatment or the like.

In order to achieve the object of the present invention, the magnetic recording medium 10 is required to have a loss modulus E₂ at 0.5 Hz at a temperature of 130° C. of 0.18 to 0.39 GPa. When the loss modulus E₂ is such a value, the substrate 12 is not limited to polyethylene naphthalate.

Moreover, in order to achieve the object of the present invention, when the substrate 12 is composed of polyethylene naphthalate, the substrate 12 is required to have a loss modulus E₂ at 0.5 Hz at a temperature of 130° C. of 0.15 to 0.37 GPa.

The method for adjusting the loss modulus E₂ of the magnetic recording medium 10 or the substrate 12 includes, for example, a method comprising the steps of subjecting, in advance, the uncoated substrate 12 to heat treatment at temperatures 1 to 25° C. lower than the glass transition temperature Tg of the substrate 12, slowly cooling the substrate to room temperature after the heat treatment, and then subjecting the cooled substrate to coating and drying.

It is important that the drying temperature after the coating is not higher than the glass transition temperature Tg of the substrate 12. This is because if the drying temperature exceeds the glass transition temperature Tg of the substrate 12, creep properties that is in relaxation may return to the original properties, and the loss modulus at 0.5 Hz at a temperature of 130° C. may become 0.40 GPa or more.

Other properties of the substrate 12 will now be described. The surface of the substrate 12 to which the intermediate layer 14 is applied has a center line surface roughness in the range of generally 0.1 nm to 10 nm, preferably 0.2 nm to 6 nm, and more preferably 0.5 nm to 4.5 nm.

The substrate 12 has a longitudinal Young's modulus (modulus of longitudinal elasticity) of 5 Gpa or more, preferably 6 Gpa or more, and more preferably 8 Gpa or more, and has a transverse Young's modulus of 3 Gpa or more, preferably 4 Gpa or more. Moreover, the substrate 12 preferably has a heat shrinkage at 100° C. for 30 minutes of 3% or less, more preferably 1.5% or less, and has a heat shrinkage factor at 80° C. for 30 minutes of preferably 1% or less, more preferably 0.5% or less.

The substrate 12 preferably has a strength at break of 5 to 100 kgf/mm² (49 to 980 MPa) and a modulus of elasticity of 100 to 2,000 kgf/mm² (≅0.98 to 19.6 GPa). The substrate 12 has a temperature coefficient of expansion of generally 10⁻⁴ to 10⁻⁸/° C., preferably 10⁻⁵ to 10⁻⁶/° C. and has a humidity coefficient of expansion of 10⁻⁴/RH % or less, preferably 10⁻⁵/RH % or less. Preferably, thermal properties, dimensional properties and mechanical strength properties as described above are substantially the same in every direction within the substrate with a difference of 10% or less.

(Magnetic Layer)

The magnetic layer 16 preferably has a thickness of 40 to 200 nm, more preferably 50 to 200 nm, and most preferably 80 to 200 nm. The optimum thickness range can be determined according to the recording and reproduction system to be applied. Generally, when the thickness is less than 40 nm, sufficient output and C/N cannot be obtained due to the reduction of output. On the other hand, when the thickness is more than 200 nm, a noise component increases to reduce the C/N.

Ferromagnetic metal (preferably alloy) powder mainly composed of α-Fe is preferred as a ferromagnetic powder to be used for the magnetic layer 16. The ferromagnetic powder may contain, besides the specified atom, atoms such as Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr and B. In particular, the ferromagnetic powder preferably contains, besides α-Fe, at least one of Al, Si, Ca, Y, Ba, La, Nd, Co, Ni and B, and more preferably contains at least one of Co, Y and Al.

The content of Co relative to Fe is preferably 0 to 40 atomic percent, more preferably 15 to 35 atomic percent, and most preferably 20 to 35 atomic percent. The content of Y is preferably 1.5 to 15 atomic percent, more preferably 3 to 12 atomic percent. The content of Al is preferably 1.5 to 15 atomic percent, more preferably 3 to 12 atomic percent.

The ferromagnetic powder may be treated with dispersants, lubricants, surfactants, antistatic agents or the like in advance, before they are dispersed. Specifically, these treatments are described in Japanese Examined Application Publication Nos. 44-14090, 45-18372, 47-22062, 47-22513, 46-28466, 46-38755, 47-4286, 47-12422, 47-17284, 47-18509, 47-18573, 39-10307, and 46-39639; and U.S. Pat. Nos. 3,026,215, 3,031,341, 3,100,194, 3,242,005, and 3,389,014.

The ferromagnetic alloy (fine) powders may contain a small amount of hydroxides or oxides. The ferromagnetic alloy (fine) powders which can be used may include those obtained by known production methods, including the following methods: a method in which complex organic acid salts (mainly oxalates) are reduced with a reducing gas such as hydrogen; a method in which iron oxides are reduced with a reducing gas such as hydrogen to obtain Fe or Fe—Co particles; a method in which metal carbonyl compounds are thermally decomposed; a method in which an aqueous solution of a ferromagnetic metal compound is reduced by adding a reducing agent such as sodium boron hydride, hypophosphite, or hydrazine; and a method in which a metal is vaporized in a low pressure inert gas atmosphere to obtain fine powders.

The thus obtained ferromagnetic alloy powders for use in the present invention may be subjected to known gradual oxidation treatment, that is, to any of a method in which the powders are immersed in an organic solvent and then dried; a method in which the powders are immersed in an organic solvent, an oxygen-containing gas is charged into the solvent to form an oxide film on surfaces of the powders, and then the powders are dried; and a method in which an oxide film is formed on surfaces of the powders by regulating partial pressure of oxygen gas and an inert gas without using an organic solvent.

The ferromagnetic powder has a specific surface area (S BET) as measured by the BET method of generally 40 to 80 m²/g, preferably 45 to 70 m²/g. When the ferromagnetic powder has a specific surface area of less than 40 m²/g, noise is increased, and when it has a specific surface area of more than 80 m²/g, it is difficult to obtain sufficient surface properties. Thus, both of these cases are not preferred. The ferromagnetic powder in the magnetic layer 16 has a crystallite size of generally 80 to 180 Å, preferably 100 to 180 Å, and more preferably 110 to 175 Å. The ferromagnetic powder has an average major axis length or an average plate diameter of generally 30 nm to 100 nm, preferably 30 nm to 75 nm.

The ferromagnetic powder preferably has an average acicular ratio or an average tabular diameter ratio of 5 to 15, more preferably 6 to 12. The acicular ratio is represented by the ratio of the average major axis length as measured by a transmission electron microscope to the crystallite size as obtained by X-ray diffraction. The magnetic metal powder has a σs of generally 70 to 180 A·m²/kg, preferably 80 to 170 A·m²/kg. The magnetic powder has a coercive force of preferably 119 to 318 kA/m, more preferably 159 to 279 kA/m, and most preferably 183 to 239 kA/m.

The ferromagnetic metal powder preferably has a moisture content of 0.1 to 2%. The moisture content of the ferromagnetic powder is preferably optimized depending on the type of binders. The pH of the ferromagnetic powder is preferably optimized depending on the combination with binders to be used. The pH is in the range of generally 6 to 12, preferably 7 to 11. The ferromagnetic powder may be optionally surface treated to form the powders containing Al, Si, P or oxides thereof. The amount of these atoms or oxides thereof is 0.1 to 10% based on the ferromagnetic powder. The surface treatment is preferred in that the adsorption of lubricants such as fatty acids is thereby reduced to 100 mg/m² or less.

The adsorption of SA (stearic acid) on the ferromagnetic metal powder (a measure of the basic point on the surface) is 1 to 15 μmol/m², preferably 2 to 10 μmol/m², and more preferably 3 to 8 μmol/m². When the ferromagnetic metal powder having a high adsorption of stearic acid is used, the powder is preferably surface-modified with an organic substance which is strongly adsorbed on the surface to prepare a magnetic recording medium.

The ferromagnetic powder may contain water-soluble inorganic ions such as Na, Ca, Fe, Ni and Sr. It is preferred that these ions be not substantially contained, but they hardly affect the properties of the powder if the content is 300 ppm or less. Further, it is preferred that the ferromagnetic powder for use in the present invention have smaller amount of holes, and the content is 20% by volume or less, preferably 5% by volume or less. Furthermore, the shape of the ferromagnetic powder may be acicular, rice grain-like, or spindle-like as long as the characteristics of the particle size as described above are satisfied.

The SFD (Switching Field Distribution) of the ferromagnetic powder itself should rather be small, preferably 0.6 or less. The distribution of Hc of the ferromagnetic powder needs to be narrower. When the SFD is less than 0.6, the magnetic recording medium has good electromagnetic transducing characteristics, has high output, and shows sharp magnetic inversion to result in the smaller peak shift. These properties provide a magnetic recording medium suitable for high density digital magnetic recording. A narrow distribution of the Hc can be obtained by any of the methods including improvement in particle size distribution of goethite, use of monodisperse α-Fe₂O₃, and prevention of sintering, in the ferromagnetic powder.

Examples of the carbon black for use in the magnetic layer 16 may include furnace black for rubber, thermal black for rubber, black for coloring, acetylene black and the like. The carbon black preferably has a specific surface area (S BET) of 5 to 500 m²/g, a DBP oil absorption of 10 to 400 ml/100 g, an average particle size of 5 nm to 300 nm, a pH of 2 to 10, a moisture content of 0.1 to 10% by mass, and a tap density of 0.1 to 1 g/ml.

Specific examples of the carbon black include BLACKPEARLS 2000, 1300, 1000, 900, 800, and 700, and VULCAN XC-72 manufactured by Cabot Corporation; #80, #60, #55, #50, and #35 manufactured by Asahi Carbon Co., Ltd.; #2400B, #2300, #900, #1000, #30, #40, and #10B manufactured by Mitsubishi Chemical Corporation; and CONDUCTEX SC, RAVEN 150, 50, 40, and 15 manufactured by Columbian Carbon Co.

The carbon black for use in the present invention may be subjected to surface treatment with a dispersant or the like, grafting with a resin, or graphitization of part of the surface thereof. The carbon black may also be dispersed in a binder prior to addition to a magnetic coating solution. The carbon black may be used singly or in combination.

When the carbon black is used, it is preferably used in an amount of 0.1 to 30% by mass based on the amount of the ferromagnetic powder. The carbon black has the functions of preventing static buildup of the magnetic layer 16, reducing the coefficient of friction, imparting light-shielding properties, and improving the film strength. Such functions vary depending upon the type of carbon black. Accordingly, it is of course possible to appropriately choose the type, the amount and the combination of the carbon black for use in the present invention as desired according to the intended purpose on the basis of the above-mentioned various properties such as the particle size, the oil absorption, the electrical conductivity, and the pH in the magnetic layer 16 and the intermediate layer 14. Regarding carbon black that can be used in the magnetic layer 16 of the present invention, for example, those described in “Kaabon Burakku Binran (Carbon Black Handbook)” (edited by the Carbon Black Association of Japan) can be referred to.

(Intermediate Layer)

Next, the intermediate layer 14 of the present invention will be described in detail. An inorganic non-magnetic powder is used for the intermediate layer 14. The inorganic non-magnetic powder can be selected from inorganic compounds such as a metal oxide, a metal carbonate, a metal sulfate, a metal nitride, a metal carbide, and a metal sulfide.

As the inorganic compound, for example, α-alumina with an α-component proportion of 90% or more, β-alumina, γ-alumina, Θ-alumina, silicon carbide, chromium oxide, cerium oxide, α-iron oxide, hematite, goethite, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide and the like can be used singly or in combination.

Particularly, titanium dioxide, zinc oxide, iron oxide and barium sulfate are preferred in that they have narrow particle distribution and have numbers of devices for imparting function. Titanium dioxide and α-iron oxide are more preferred. These non-magnetic powders preferably have a particle size of 0.005 to 0.5 μm, but optionally, it is also possible to combine non-magnetic powders having different particle sizes or use a non-magnetic powder having a wide particle size distribution singly so that the same effect can be obtained.

Particularly preferred is a non-magnetic powder having a particle size of 0.01 to 0.2 μm. In particular, when the non-magnetic powder is a granular metal oxide, it preferably has an average particle size of 0.08 μm or less, and when the non-magnetic powder is an acicular metal oxide, it generally has a major axis of 0.2 μm or less, preferably 0.15 μm or less, and more preferably 0.1 μm or less.

The non-magnetic powder generally has an acicular ratio of 2 to 20, preferably 3 to 10, and it generally has a tap density of 0.05 to 2 g/ml, preferably 0.2 to 1.5 g/ml. The non-magnetic powder generally has a moisture content of 0.1 to 5% by mass, preferably 0.2 to 3% by mass, and more preferably 0.3 to 1.5% by mass. The magnetic powder generally has a pH of 2 to 11, but the pH is most preferably between 5.5 and 10. The non-magnetic powder having these properties is highly adsorptive to functional groups, which increases dispersibility thereof and provides high mechanical strength to the coating film thereof.

The non-magnetic powder generally has a specific surface area of 1 to 100 m²/g, preferably 5 to 80 m²/g, and more preferably 10 to 70 m²/g. The non-magnetic powder preferably has a crystallite size of 0.004 to 1 μm, more preferably 0.04 to 0.1 μm. The non-magnetic powder generally has an oil absorption using DBP (dibutyl phthalate) of 5 to 100 ml/100 g, preferably 10 to 80 ml/100 g, and more preferably 20 to 60 m/100 g.

The non-magnetic powder generally has a specific gravity of 1 to 12, preferably 3 to 6. The shape of the non-magnetic powder may be acicular, spherical, polyhedral or tabular. The non-magnetic powder preferably has a Mohs hardness of 4 to 10. The non-magnetic powder has a SA (stearic acid) adsorption of generally 1 to 20 μmol/m², preferably 2 to 15 μmol/m², and more preferably 3 to 8 μmol/m². It is preferred that pH be within a range of 3 to 6.

The surface of the non-magnetic powder may preferably be surface-treated so that Al₂O₃, SiO₂, TiO₂, ZrO₂, SnO₂, Sb₂O₃, ZnO, or Y₂O₃ is present on the surface thereof. In particular, it is preferred for dispersibility that Al₂O₃, SiO₂, TiO₂ or ZrO₂, more preferably Al₂O₃, SiO₂ or ZrO₂, be present. These compounds may be used singly or in combination. Further, a coprecipitated surface treatment layer may be used depending on purposes, or a method may be adopted in which a surface may be first treated with alumina followed by treating the surface layer with silica and vice versa. Furthermore, the surface treated layer may be a porous layer depending on purposes, but it is generally preferred that it be homogenous.

Specific examples of the non-magnetic powder used in the intermediate layer 14 include Nanotite manufactured by Showa Denko K. K.; HIT-100 and ZA-G1 manufactured by Sumitomo Chemical Co., Ltd.; α-hematite DPN-250, DPN-250BX, DPN-245, DPN-270BX, DPN-500BX, DBN-SA1 and DBN-SA3 manufactured by Toda Kogyo Corp.; TTO-51B, TTO-55A, TTO-55B, TTO-55C, TTO-55S, TTO-55D, SN-100, α-hematite E270, E271, E300 and E303 manufactured by Ishihara Sangyo Kaisha Ltd.; titanium oxide STT-4D, STT-30D, STT-30, STT-65C, and α-hematite α-40 manufactured by Titan Kogyo Kabushiki Kaisha; MT-100S, MT-100T, MT-150W, MT-500B, MT-600B, MT-100F and MT-500HD manufactured by Tayca Corporation; FINEX-25, BF-1, BF-10, BF-20 and ST-M manufactured by Sakai Chemical Industry Co., Ltd.; DEFIC-Y and DEFIC-R manufactured by Dowa Mining Co., Ltd.; AS2BM and TiO2P25 manufactured by Nippon Aerosil Co., Ltd.; 100A and 500A manufactured by Ube Industries, Ltd.; and fired products thereof. Most preferred non-magnetic powder is titanium oxide and α-iron oxide.

The intermediate layer 14 can be mixed with carbon black to reduce surface electric resistance Rs and to reduce optical transmittance, which are known effects, as well as to obtain desired micro-Vickers hardness. The type of carbon black for use in the intermediate layer 14 may include furnace black for rubber, thermal black for rubber, black for coloring, acetylene black and the like.

The carbon black for use in the intermediate layer 14 generally has a specific surface area (S BET) of 100 to 500 m²/g, preferably 150 to 400 m²/g; and a DBP oil absorption of generally 20 to 400 ml/100 g, preferably 30 to 400 ml/100 g. The carbon black generally has an average particle size of 5 nm to 80 nm, preferably 10 nm to 50 nm, and more preferably 10 nm to 40 nm. The carbon black preferably has a pH of 2 to 10, a moisture content of 0.1 to 10%, and a tap density of 0.1 to 1 g/ml.

Specific examples of the carbon black include BLACKPEARLS 2000, 1300, 1000, 900, 800, 880 and 700, and VULCAN XC-72, manufactured by Cabot Corporation; #3050B, #3150B, #3250B, #3750B, #3950B, #950, #650B, #970B, #850B, MA-600, MA-230, #4000 and #4010 manufactured by Mitsubishi Chemical Corporation; CONDUCTEX SC, RAVEN 8800, 8000, 7000, 5750, 5250, 3500, 2100, 2000, 1800, 1500, 1255 and 1250 manufactured by Columbian Carbon Co.; and Ketjen Black EC manufactured by Ketjen Black International Company.

The carbon black for use in the present invention may be subjected to surface treatment with a dispersant or the like, grafting with a resin, or graphitization of part of the surface thereof. The carbon black may also be dispersed in a binder prior to addition to a coating solution. The carbon black may be used in the range of 50% by mass or less based on the above described inorganic powder, and in the range of 40% or less based on the total mass of the intermediate layer. The carbon black may be used singly or in combination.

Organic powder may also be added to the intermediate layer 14 depending on purposes. Examples of the organic powder include an acrylic-styrene resin powder, a benzoguanamine resin powder, a melamine resin powder, and a phthalocyanine dye. A polyolefin resin powder, a polyester resin powder, a polyamide resin powder, a polyimide resin powder, and a polyethylene fluoride resin may also be used. The methods as described in Japanese Patent Application Laid-Open Nos. 62-18564 and 60-255827 can be used for producing them.

Binder resins, lubricants, dispersants, additive, solvents, dispersing methods and the like used for the magnetic layer 16 as described below can also be applied to those for the intermediate layer 14. In particular, with respect to the amounts and the types of binder resins and the amounts and the types of additives and dispersants, any known prior art techniques regarding the magnetic layer 16 can also be applied to the intermediate layer 14.

(Back Coat Layer)

The number of protrusions in the back coat layer 18 having a height of 50 nm or more determined from the root mean square surface as measured by an optical surface roughness tester is preferably 0.03 pieces/100 μm² to 0.2 pieces/100 μm².

Generally, magnetic tapes for computer data recording are strongly requested to have repeated runnability as compared to video tapes and audio tapes. In order to maintain such a high running durability, the back coat layer preferably contains carbon black.

Carbon black is preferably used by combining two types thereof having different average particle sizes. In this case, it is preferred that fine-grain carbon black having an average particle size of 10 to 50 nm and coarse-grain carbon black having an average particle size of 70 to 300 nm be used in combination.

The back coat layer can generally have a low surface electric resistance and a low optical transmittance by adding fine-grain carbon black as described above. Some magnetic recording device often utilizes the optical transmittance of a tape as the signal of operation. In such a case, addition of fine-grain carbon black is particularly effective. In addition, fine-grain carbon black is generally excellent in holding power of a liquid lubricant and contributes to a reduction in the coefficient of friction when a lubricant is used in combination with it.

Specific commercial products of fine-grain carbon black include RAVEN 2000B (18 nm); RAVEN 1500B (17 nm) (manufactured by Columbian Carbon Co.); BP 800 (17 nm) (manufactured by Cabot Corporation); PRINTEX 90 (14 nm), PRINTEX 95 (15 nm), PRINTEX 85 (16 nm) and PRINTEX 75 (17 nm) (manufactured by Degussa AG); #3950 (16 nm) (manufactured by Mitsubishi Chemical Corporation); and Asahi #51 (38 nm) (manufactured by Asahi Carbon Co., Ltd.).

Specific examples of commercial products of coarse-grain carbon black include Rega 199 (100 nm) (manufactured by Cabot Corporation); Thermal black (270 nm) (manufactured by Cancarb Limited.); and RAVEN MTP (275 nm) (manufactured by Columbian Carbon Co.).

When two types of carbon black having different average particle sizes are used in the back coat layer 18, the ratio of the content (mass ratio) of the fine-grain carbon black having an average particle size of 10 to 50 nm to the coarse-grain carbon black having an average particle size of 70 to 300 nm (the former/the latter) is preferably in the range of 1/100 to 1/1, more preferably 1/20 (5/100) to 1/2 (50/100).

The content of carbon black in the back coat layer 18 (the total amount thereof when two types are used) is generally in the range of 30 to 100 parts by mass, preferably in the range of 45 to 95 parts by mass, based on 100 parts by mass of the binder.

Inorganic powder may be used in the back coat layer 18. Two types of inorganic powder having different hardness are preferably used in combination. Specifically, a soft inorganic powder having a Mohs hardness of 3 to 4.5 and a hard inorganic powder having a Mohs hardness of 5 to 9 are preferably used in combination. By the addition of a soft inorganic powder having a Mohs hardness of 3 to 4.5, a friction coefficient can be stabilized against repeated running. Moreover, a sliding guide pole is not scratched off with the hardness within this range. The average particle size of such a soft inorganic powder is preferably in the range of 30 to 50 nm.

Examples of soft inorganic powders having a Mohs hardness of 3 to 4.5 may include, for example, calcium sulfate, calcium carbonate, calcium silicate, barium sulfate, magnesium carbonate, zinc carbonate and zinc oxide. These soft inorganic powders can be used singly or in combination of two or more. Among them, calcium carbonate is particularly preferred.

The content of the soft inorganic powder in the back coat layer 18 is preferably 0 to 140 parts by mass, more preferably 0 to 100 parts by mass, based on 100 parts by mass of the carbon black.

By the addition of a hard inorganic powder having a Mohs hardness of 5 to 9, the strength of the back coat layer 18 is increased and the running durability is improved. When such hard inorganic powders are used together with carbon black and the above-described soft inorganic powders, deterioration due to repeated sliding is reduced and a strong back coat layer 18 can be obtained. Moreover, an appropriate abrasive property is given by the addition of the inorganic powder and the adhesion of scratched powders to a tape guide pole or the like is reduced. In particular, when the hard inorganic powder is used in combination with a soft inorganic powder (among others, calcium carbonate), sliding characteristics against a guide pole having a rough surface is improved and the stabilization of a friction coefficient of the back coat layer can also be brought about.

The average particle size of hard inorganic powders is preferably in the range of 80 to 250 nm (more preferably 100 to 210 nm). Examples of hard inorganic powders having a Mohs hardness of 5 to 9 may include, for example, α-iron oxide, α-alumina, and chromium oxide (Cr₂O₃). These powders may be used alone or in combination. Of the above hard inorganic powders, α-iron oxide or α-alumina is preferred. The content of hard inorganic powders is generally 0 to 30 parts by mass, preferably 0 to 20 parts by mass, based on 100 parts by mass of the carbon black.

When the above soft inorganic powder and hard inorganic powder are used in combination in the back coat layer 18, it is preferred to use them selectively so that the difference of hardness between the soft and hard inorganic powders is 2 or more (more preferably 2.5 or more, and most preferably 3 or more).

It is preferred that two kinds of inorganic powders each having a specific average particle size and different in Mohs hardness and two kinds of carbon blacks each having a different average particle size be contained in the back coat layer 18. In particular, it is preferred that calcium carbonate be contained as the soft inorganic powder in the above combination.

The back coat layer 18 may contain a lubricant. The lubricant can be arbitrarily selected from among the lubricants which can be used in the intermediate layer 14 or the magnetic layer 16 as described above. The lubricant is added to the back coat layer 18 in an amount generally in the range of 1 to 5 parts by mass based on 100 parts by mass of the binder.

(Other Materials Used for Manufacturing the Magnetic Recording Medium)

Next, other materials used for manufacturing the magnetic recording medium 10 will be described.

The binders, lubricants, dispersants, additives, solvents, dispersing methods and the like used for the magnetic layer 16, the intermediate layer 14 and the back coat layer 18 can be commonly applied to each of the magnetic layer 16, the intermediate layer 14 and the back coat layer 18. In particular, with respect to the amounts and the types of binders and the amounts and the types of additives and dispersants, any known prior art techniques regarding the magnetic layer 16 can also be applied to the intermediate layer 14 and the back coat layer 18.

Conventionally known thermoplastic resins, thermosetting resins, reactive resins and mixtures of thereof are used as a binder in the present invention. Thermoplastic resins having a glass transition temperature of −100 to 150° C., a number average molecular weight of 1,000 to 200,000, preferably 10,000 to 100,000, and a polymerization degree of about 50 to about 1,000 can be used in the present invention.

Examples of thermoplastic resins include polymers or copolymers containing, as the constituting unit, vinyl chloride, vinyl acetate, vinyl alcohol, maleic acid, acrylic acid, acrylic ester, vinylidene chloride, acrylonitrile, methacrylic acid, methacrylate ester, styrene, butadiene, ethylene, vinyl butyral, vinyl acetal or vinyl ether; polyurethane resins; and various rubber resins.

Further, examples of thermosetting resins or reactive resins include phenolic resins, epoxy resins, curable type polyurethane resins, urea resins, melamine resins, alkyd resins, acrylic reactive resins, formaldehyde resins, silicone resins, epoxy-polyamide resins, mixtures of polyester resins and isocyanate prepolymers, mixtures of polyesterpolyols and polyisocyanates, and mixtures of polyurethanes and polyisocyanates.

These resins are described in detail in “Plastic Handbook”, published by Asakura Shoten. It is also possible to use known electron beam-curable resins in each layer. Examples of these resins and production methods thereof are disclosed in detail in Japanese Patent Application Laid-Open No. 62-256219.

These resins may be used alone or in combination. Examples of preferred combinations include at least one resin selected from vinyl chloride resins, vinyl chloride-vinyl acetate copolymers, vinyl chloride-vinyl acetate-vinyl alcohol copolymers, and vinyl chloride-vinyl acetate-maleic anhydride copolymers with polyurethane resins, and combinations of these resins with polyisocyanates.

As the polyurethane resins, those having known structures, for example, polyester polyurethane, polyether polyurethane, polyether polyester polyurethane, polycarbonate polyurethane, polyester polycarbonate polyurethane, and polycaprolactone polyurethane can be used. For the purpose of further improving dispersibility and durability with respect to all the binders described above, it is optionally preferred that at least one polar group selected from the following be introduced into the binders by copolymerization or addition reaction: —COOM, —SO₃M, —OSO₃M, —P═O(OM)₂, —O—P═O(OM)₂ (wherein M represents a hydrogen atom or an alkali metal salt group), —OH, —NR₂, —N₊R₃ (wherein R represents a hydrocarbon group), an epoxy group, —SH, and —CN. The content of the polar group is 10⁻¹ to 10⁻⁸ mol/g, preferably 10⁻² to 10⁻⁶ mol/g.

Specific examples of the above described binders include VAGH, VYHH, VMCH, VAGF, VAGD, VROH, VYES, VYNC, VMCC, XYHL, XYSG, PKHH, PKHJ, PKHC and PKFE manufactured by The Dow Chemical Company; MPR-TA, MPR-TA5, MPR-TAL, MPR-TSN, MPR-TMF, MPR-TS, MPR-TM and MPR-TAO manufactured by Nisshin Chemical Industry Co., Ltd.; 1000W, DX80, DX81, DX82, DX83 and 100FD manufactured by Denki Kagaku Kogyo K.K.; MR-104, MR-105, MR-110, MR-100, MR-555 and 400X-110A manufactured by ZEON Corporation; Nippollan N2301, N2302 and N2304 manufactured by Nippon Polyurethane Industry Co., Ltd.; Pandex T-5105, T-R3080, T-5201, Burnock D-400, D-210-80, Crisvon 6109 and 7209 manufactured by Dainippon Ink and Chemicals Incorporated; Vylon UR8200, UR8300, UR8700, RV530 and RV280 manufactured by Toyobo, Ltd.; Daipheramine 4020, 5020, 5100, 5300, 9020, 9022 and 7020 manufactured by Dainichiseika Color & Chemicals Mfg. Co., Ltd.; MX5004 manufactured by Mitsubishi Chemical Corporation; Sunprene SP-150 manufactured by Sanyo Chemical Industries, Ltd.; and Salan F310 and F210 manufactured by Asahi Kasei Corporation.

The amount of the binder for use in the intermediate layer 14 and the magnetic layer 16 in the present invention is in the range of 5 to 50%, preferably in the range of 10 to 30%, based on the non-magnetic powder and the magnetic powder, respectively. When vinyl chloride resins, polyurethane resins and polyisocyanates are used, they are preferably used in combination in an amount of 5 to 30%, 2 to 20% and 2 to 20%, respectively. However, for instance, when the corrosion of a head is caused by a slight amount of chlorine due to dechlorination, it is possible to use polyurethane alone or a combination of polyurethane and isocyanate alone.

When polyurethane is used, it preferably has a glass transition temperature of −50° C. to 150° C., preferably 0° C. and 100° C.; an elongation at break of 100 to 2,000%; a stress at break of 0.05 to 10 kgf/mm² (≅0.49 to 98 MPa); and an yield point of 0.05 to 10 kgf/mm² (≅0.49 to 98 MPa).

The magnetic recording medium 10 in the present invention comprise two or more layers. Accordingly, it is of course possible to vary the amount of the binder; the amount of the vinyl chloride resin, polyurethane resin, polyisocyanate or other resins contained in the binder; the molecular weight and the amount of polar groups of each resin forming the magnetic layer 16; or the physical properties of the above-described resins in the intermediate layer 14 and the magnetic layer 16 according to necessity. These factors should be rather optimized in respective layers, and known techniques with respect to multiple magnetic layers can be applied to optimize these factors. For example, when the amount of the binder is varied in each layer, it is effective to increase the amount of the binder contained in the magnetic layer 16 to reduce scratches on the surface of the magnetic layer. For improving the head touch against the head, it is effective to increase the amount of the binder in the intermediate layer 14 to impart flexibility.

Examples of the polyisocyanates for use in the magnetic recording medium of the present invention may include isocyanates such as tolylenediisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, and triphenylmethane triisocyanate; reaction products of these isocyanates with polyalcohols; and polyisocyanates formed by condensation of isocyanates.

These isocyanates are commercially available under the trade names of Coronate L, Coronate HL, Coronate 2030, Coronate 2031, Millionate MR and Millionate MTL manufactured by Nippon Polyurethane Industry Co., Ltd.; Takenate D-102, Takenate D-110N, Takenate D-200 and Takenate D-202 manufactured by Mitsui Chemicals Polyurethanes, Inc.; and Desmodur L, Desmodur IL, Desmodur N and Desmodur HL manufactured by Sumika Bayer Urethane Co., Ltd. These isocyanates may be used alone or in combination of two or more thereof in each layer, taking advantage of a difference in curing reactivity.

Known materials essentially having a Mohs hardness of 6 or more are used alone or in combination as the abrasives in the magnetic recording medium of the present invention. Examples of such abrasives include α-alumina having an α-conversion rate of 90% or more, β-alumina, silicon carbide, chromium oxide, cerium oxide, α-iron oxide, corundum, synthetic diamond, silicon nitride, silicon carbide, titanium carbide, titanium oxide, silicon dioxide, and boron nitride.

Moreover, the composites composed of these abrasives (abrasives surface-treated with other abrasives) may also be used. Compounds or elements other than the main component may be contained in these abrasives, but the intended effect can be attained so far as the content of the main component is 90% by mass or more. Preferably, these abrasives have a tap density of 0.3 to 2 g/ml, a moisture content of 0.1 to 5% by mass, a pH of 2 to 11, and a specific surface area (S BET) of 1 to 30 m²/g.

The shape of the abrasives for use in the present invention may be any of acicular, spherical and die-like shapes, but those having a shape partly with edges are preferred because a high abrasive property can be obtained. Specific examples of the abrasives for use in the magnetic recording medium of the present invention include AKP-20, AKP-30, AKP-50, HIT-50, HIT-55, HIT-60A, HIT-70 and HIT-100 manufactured by Sumitomo Chemical Co., Ltd.; G5, G7 and S-1 manufactured by Nippon Chemical Industry Co., Ltd.; and TF-100 and TF-140 manufactured by Toda Kogyo Corporation. It is of course possible to appropriately choose the type, the amount and the combination of the abrasives as desired according to the intended purpose in the magnetic layer 16 and the intermediate layer 14. These abrasives may be subjected to dispersion treatment with a binder in advance before they are added to a magnetic coating solution.

As the additives for use in the magnetic recording medium of the present invention, those having a lubricating effect, an antistatic effect, a dispersing effect and a plasticizing effect can be used. Examples of such additives include molybdenum disulfide, tungsten graphite disulfide, boron nitride, graphite fluoride, silicone oils, silicones having a polar groups, fatty acid-modified silicones, fluorine-containing silicones, fluorine-containing alcohols, fluorine-containing esters, polyolefins, polyglycols, alkyl phosphates and alkali metal salts thereof, alkyl sulfates and alkali metal salts thereof, polyphenyl ethers, fluorine-containing alkyl sulfates and alkali metal salts thereof, monobasic fatty acid having 10 to 24 carbon atoms (which may contain an unsaturated bond or may be branched) and metal salts thereof (with Li, Na, K or Cu), or mono-, di-, tri-, tetra-, penta- and hexahydric alcohols having 12 to 22 carbon atoms (which may contain an unsaturated bond or may be branched), alkoxy alcohols having 12 to 22 carbon atoms, fatty acid monoesters, fatty acid diesters or fatty acid triesters composed of a monobasic fatty acid having 10 to 24 carbon atoms (which may contain an unsaturated bond or may be branched) and any one of mono-, di-, tri-, tetra-, penta- and hexahydric-alcohols having 2 to 12 carbon atoms (which may contain an unsaturated bond or may be branched), fatty acid esters of monoalkyl ethers of alkylene oxide polymers, fatty acid amides having 8 to 22 carbon atoms, and aliphatic amines having 8 to 22 carbon atoms.

Specific examples of the above fatty acids, alcohols and esters include lauric acid, myristic acid, palmitic acid, stearic acid, behenic acid, butyl stearate, oleic acid, linoleic acid, linolenic acid, elaidic acid, octyl stearate, amyl stearate, isooctyl stearate, octyl myristate, butoxyethyl stearate, anhydrosorbitan monostearate, anhydrosorbitan distearate, anhydrosorbitan tristearate, oleyl alcohol, and lauryl alcohol.

In addition, nonionic surfactants such as alkylene oxides, glycerols, glycidols and alkylphenol-ethylene oxide adducts; cationic surfactants such as cyclic amines, ester amides, quaternary ammonium salts, hydantoin derivatives, heterocyclic compounds, phosphoniums and sulfoniums; anionic surfactants containing an acidic group such as carboxylic acid, sulfonic acid, phosphoric acid, a sulfate group and a phosphate group; and amphoteric surfactants such as amino acids, aminosulfonic acids, sulfates or phosphates of amino alcohols, and alkylbetaines can also be used.

These surfactants are described in detail in Kaimen Kasseizai Binran (Handbook of Surfactants) (published by Sangyo Tosho Co., Ltd.). These lubricants and antistatic agents need not be 100% pure and may contain impurities such as isomers, unreacted products, byproducts, decomposed products and oxides, in addition to the main component. However, the content of such impurities is preferably 30% or less, more preferably 10% or less.

The types and amounts of these lubricants and surfactants for use in the present invention can be varies as required in the intermediate layer 14 and the magnetic upper layer. For example, the intermediate layer 14 and the magnetic upper layer can separately contain different fatty acids each having a different melting point so as to prevent bleeding out of the fatty acids to the surface, or different esters each having a different boiling point or a different polarity so as to prevent bleeding out of the esters to the surface. Also, the amount of the surfactant is controlled so as to improve the coating stability, or the amount of the lubricant is increased in the intermediate layer so as to improve the lubricating effect. The examples are by no means limited there to. All or a part of the additives to be used in the present invention may be added to the magnetic coating solution in any step of the preparation of the magnetic coating solution. For example, the additives may be blended with the ferromagnetic powder before the kneading step; may be added in the step of kneading the ferromagnetic powder, the binder and the solvent; may be added in the dispersing step; may be added after the dispersing step; or may be added just before coating. Alternatively, depending on purpose, there is a case where the purpose can be achieved by coating all or part of the additives simultaneously with or successively after the coating of the magnetic layer 16. Alternatively, depending on purpose, the lubricants may be coated on the surface of the magnetic layer after calendering treatment or after completion of slitting.

Examples of the commercially available products of the lubricants include NAA-102, NAA-415, NAA-312, NAA-160, NAA-180, NAA-174, NAA-175, NAA-222, NAA-34, NAA-35, NAA-171, NAA-122, NAA-142, NAA-160, NAA-173K, hydrogenated castor oil fatty acid, NAA-42, NAA-44, Cation SA, Cation MA, Cation AB, Cation BB, Nymeen L-201, Nymeen L-202, Nymeen S-202, Nonion E-208, Nonion P-208, Nonion S-207, Nonion K-204, Nonion NS-202, Nonion NS-210, Nonion HS-206, Nonion L-2, Nonion S-2, Nonion S-4, Nonion O-2, Nonion LP-20R, Nonion PP-40R, Nonion SP-60R, Nonion OP-80R, Nonion OP-85R, Nonion LT-221, Nonion ST-221, Nonion OT-221, Monogly MB, Nonion DS-60, Anon BF, Anon LG, butyl stearate, butyl laurate, and erucic acid manufactured by NOF Corporation; oleic acid manufactured by Kanto Chemical Co., Inc.; FAL-205 and FAL-123 manufactured by Takemoto Oil & Fat Co., Ltd.; Enujelv LO, Enujolv IPM and Sansocizer E4030 manufactured by New Japan Chemical Co., Ltd.; TA-3, KF-96, KF-96L, KF96H, KF410, KF420, KF965, KF54, KF50, KF56, KF907, KF851, X-22-819, X-22-822, KF905, KF700, KF393, KF-857, KF-860, KF-865, X-22-980, KF-101, KF-102, KF-103, X-22-3710, X-22-3715, KF-910, and K1F-3935 manufactured by Shin-Etsu Chemical Co., Ltd.; Armid P, Armid C, Armoslip CP, Duomeen TDO manufactured by Lion Corporation; BA-41G manufactured by Nisshin OilliO Group, Ltd.; Profan 2012E, Newpol PE61, Ionet MS-400, Ionet MO-200, Ionet DL-200, Ionet DS-300, Ionet DS-1000 and Ionet DO-200 manufactured by Sanyo Chemical Industries, Ltd.

The following organic solvents can be used in the present invention in an arbitrary ratio: ketones such as acetone, methyl ethyl ketone, methyl isobutyl ketone, diisobutyl ketone, cyclohexanone, isophorone and tetrahydrofuran; alcohols such as methanol, ethanol, propanol, butanol, isobutyl alcohol, isopropyl alcohol and methylcyclohexanol; esters such as methyl acetate, butyl acetate, isobutyl acetate, isopropyl acetate, ethyl lactate and glycol acetate; glycol ethers such as glycol dimethyl ether, glycol monomethyl ether and dioxane; aromatic hydrocarbons such as benzene, toluene, xylene, cresol and chlorobenzene; chlorinated hydrocarbons such as methylene chloride, ethylene chloride, carbon tetrachloride, chloroform, ethylene chlorohydrin and dichlorobenzene; N,N-dimethylformamide, and hexane.

These organic solvents need not be 100% pure and may contain impurities such as isomers, unreacted products, byproducts, decomposed products, oxides and moisture in addition to the main component. However, the content of such impurities is preferably 30% or less, more preferably 10% or less.

Preferably, the organic solvent is of the same type in the magnetic layer 16 and the intermediate layer 14. The content thereof may be different in these layers. It is important that a solvent having high surface tension (such as cyclohexane or dioxane) is used in the intermediate layer 14 to improve stability of coating, and that specifically the arithmetic mean value of the content of the solvent composition in the magnetic layer 16 is not less than that in the intermediate layer 14.

The organic solvent preferably has a high polarity to some extent in order to improve dispersibility, and it is preferred that the solvent having a dielectric constant of 15 or more be contained in an amount of 50% or more in the solvent composition. In addition, the solubility parameter is preferably 8 to 11.

(Method for Manufacturing Magnetic Recording Medium)

The magnetic recording medium of the present invention can be manufactured by coating and drying the coating solution for forming each layer. The process for manufacturing the coating solution comprises at least a kneading step, a dispersing step and blending steps optionally provided before and after these steps. Each of these steps may be composed of two or more separate stages. All of the raw materials such as a ferromagnetic powder, a binder, carbon black, an abrasive, an antistatic agent, a lubricant and a solvent for use in the present invention may be added at any step at anytime. Alternatively, each raw material may be added at two or more steps dividedly. For example, polyurethane may be added dividedly at a kneading step, a dispersing step, or a blending step for adjusting viscosity after dispersion.

For manufacturing the magnetic recording medium of the present invention, conventionally known techniques can be used partly with the above steps. Powerful kneading machines such as a continuous kneader or a pressure kneader can also be used in a kneading step to obtain a magnetic recording medium having a high remanent magnetic flux density (Br). When the continuous kneader or the pressure kneader is used, all or a part of the binders (preferably 30% or more of all the binders) is kneaded with the ferromagnetic powder in an amount in the range of 15 to 500 parts by mass based on 100 parts by mass of the ferromagnetic powder.

The detail of the above kneading treatment is described in Japanese Patent Application Laid-Open Nos. 1-106338 and 64-79274. Moreover, when a coating solution of the intermediate layer 14 is prepared, it is desired that dispersing media having high specific gravity be used, preferably zirconia beads.

A method can be used in which a coating solution for forming the intermediate layer 14 containing non-magnetic powder and a binder on the flexible non-magnetic substrate 12 and a coating solution for forming the magnetic layer 16 containing ferromagnetic powder and a binder are simultaneously or successively coated on the substrate 12 (so called wet-on-wet coating) so that the magnetic layer 16 is formed on the intermediate layer 14 followed by smoothing treatment and magnetic field orientation while the coating layer is in a wet state.

Examples of the apparatus and method for coating the magnetic recording medium of a multilayer structure as described above include the following apparatus and method:

1) The intermediate layer 14 is first coated by use of a gravure coating, roll coating, blade coating or extrusion coating apparatus generally used for coating the magnetic coating solution followed by coating the upper layer by use of a substrate-pressurized extrusion coating apparatus as disclosed in Japanese Examined Application Publication No. 1-46186, Japanese Patent Application Laid-Open Nos. 60-238179 and 2-265672 while the intermediate layer 14 is in a wet state.

2) The upper and lower layers are substantially simultaneously coated by use of one coating head having two built-in slits for passing a coating solution as disclosed in Japanese Patent Application Laid-Open Nos. 63-88080, 2-17971 and 2-265672.

3) The upper and lower layers are substantially simultaneously coated by use of an extrusion coating apparatus with a backup roll as disclosed in Japanese Patent Application Laid-Open No. 2-174965.

In order to prevent reduction of electromagnetic transducing characteristics or the like of the magnetic recording medium due to coagulation of magnetic particles, it is desired that the coating solution in the coating head be subjected to shear by a method as disclosed in Japanese Patent Application Laid-Open Nos. 62-95174 and 1-236968. Moreover, the viscosity of the coating solution appropriately satisfies the numerical range as disclosed in Japanese Patent Application Laid-Open No. 3-8471.

Moreover, smoothing treatment can be performed by, for example, applying a stainless steel plate to the surface of the coating layer on the substrate 12. Other than the above method, the following methods can also be adopted such as a method by use of a solid smoother as disclosed in Japanese Examined Application Publication No. 60-57387; a method in which the coating solution is scraped and measured by use of a rod which remains at rest or is rotating opposite to the running direction of the substrate 12; or a method in which the surface of the coating solution film is smoothed by bringing a flexible sheet into face-contact with the surface.

Moreover, for the magnetic field orientation, it is preferred that a solenoid of 1,000 G or more and a cobalt magnet of 2,000 G or more be used in combination with the same pole thereof opposed to each other. Further, when the present invention is applied as a disk medium, an orientation method to randomize orientation is required.

In addition, a heat resistant plastic roll composed of epoxy, polyimide, polyamide, polyimideamide or the like can be used as the roll for calender treatment. Further, it is possible to use metal rolls for the treatment. The treatment temperature is preferably 30° C. or higher, more preferably 35° C. to 100° C. The linear pressure is preferably 200 kgf/cm, more preferably 300 kgf/cm or more.

The magnetic recording medium of the present invention has a coefficient of friction of the magnetic layer surface and the opposite surface to SUS 420J of preferably 0.5 or less, more preferably 0.3 or less; a surface resistivity of preferably 10⁴ to 10¹² ohms/sq; a modulus of elasticity at 0.5% elongation of the magnetic layer 16 in both the running and lateral directions of preferably 100 to 2,000 kgf/mm² (≅0.98 to 19.6 GPa); a strength at break of preferably 1 to 30 kgf/cm² (≅0.098 to 0.29 MPa); a modulus of elasticity of the magnetic recording medium in both the running and lateral directions of preferably 100 to 1,500 kgf/mm² (≅0.98 to 14.7 GPa); a residual elongation of preferably 0.5% or less; and a thermal shrinkage at any temperature of 100° C. or less of preferably 1% or less, more preferably 0.5% or less, and most preferably 0.1% or less.

The magnetic layer 16 and the intermediate layer 14 preferably have a glass transition temperature (a maximum point of loss modulus in the dynamic viscoelasticity measurement as measured at 110 Hz) of 50° C. to 120° C. and 0° C. to 100° C., respectively. The loss tangent is preferably 0.2 or less. When the loss tangent is too large, failure due to sticking is prone to appear.

A residual solvent contained in the magnetic layer 16 is preferably 100 mg/m² or less, more preferably 10 mg/m² or less. Both the intermediate layer 14 and the magnetic layer 16 have a percentage of void of preferably 30% by volume or less, more preferably 20% by volume or less. The percentage of void is preferably lower for obtaining high output, but in some cases a specific value should be preferably secured depending on purposes. For example, in a magnetic recording medium for data recording in which repeated use is important, higher percentage of void contributes to good running durability in many cases.

When magnetic properties of the magnetic recording medium 10 of the present invention is measured in a magnetic field of 398 kA/m (5 KOe), the squareness ratio in the tape running direction is generally 0.70 or more, preferably 0.80 or more, and more preferably 0.90 or more.

The squareness ratio in two directions at right angles to the tape running direction is preferably 80% or less of the squareness ratio in the running direction. The magnetic layer 16 preferably has an SFD (Switching Field Distribution) of 0.6 or less.

The magnetic recording medium 10 of the present invention has the intermediate layer 14 and the upper magnetic layer 16, and it is easily estimated that these physical properties can be varied between the intermediate layer 14 and the magnetic layer 16 depending on purpose. For example, the modulus of elasticity of the magnetic layer 16 is increased to improve the running durability, and simultaneously the modulus of elasticity of the intermediate layer 14 is reduced to the level lower than that of the magnetic layer 16 to improve the contact of the magnetic recording medium 10 to a head.

When the magnetic layer 16 is composed of two or more layers, physical properties of the respective magnetic layers can be designed with reference to the techniques on the known multilayer coating of the magnetic layer. For example, there are many inventions including Japanese Examined Application Publication No. 37-2218 and Japanese Patent Application Laid-Open No. 58-56228 on the technique in which the upper magnetic layer has a higher Hc than that of the intermediate layer. However, the magnetic layer 16 having a thin thickness as disclosed in the present invention enables recording by using even the magnetic layer 16 having a higher Hc.

Examples of the embodiments of the magnetic recording medium and a method for manufacturing the same according to the invention have been described above. However, the present invention is not limited to the above-described embodiments, but various aspects may be implemented.

### EXAMPLES

The present invention will be specifically described by the following examples. It will be easily understood to those skilled in the art that the components, the proportion, the order of operation and the like described in the examples can be modified in a range without departing from the spirit of the present invention.

Accordingly, the present invention should not be limited to the following examples. Parts in the examples represent parts by weight.

(Components of coating solution for magnetic layer)

| | | |
|---|---|---|
| Ferromagnetic metal powder composition: Fe/Co = 100/30 (atomic ratio) | 100 | parts |
| Hc: 189.600 kA/m (2400 Oe) | | |
| Specific surface area by BET method 70 m²/g | | |
| Average major axis length: 60 nm | | |
| Crystallite size: 13 nm (130 Angstrom) | | |
| Saturation magnetization σs: 125 A · m²/kg (125 emu/g) | | |
| Surface treatment agent: Al₂O₃, Y₂O₃ | | |
| Vinyl chloride copolymer (MR-110 manufactured by ZEON Corporation) | 12 | parts |
| —SO₃Na content: 5 × 10⁻⁶ eq/g, degree of polymerization: 350 | | |
| Epoxy group (3.5% by weight per monomer unit) | | |
| Polyester-polyurethane resin | 3 | parts |
| UR-8200 manufactured by Toyobo | | |
| α-Alumina (average particle size: 0.1 μm) | 5 | parts |
| Carbon black (average particle size: 0.08 μm) | 0.5 | parts |
| Stearic acid | 2 | parts |
| Methyl ethyl ketone | 90 | parts |
| Cyclohexanone | 30 | parts |
| Toluene | 60 | parts |

(Components of coating solution for intermediate layer)

| | | |
|---|---|---|
| Non-magnetic powder α-Fe₂O₃ hematite | 80 | parts |
| Major axis length: 0.15 μm | | |
| Specific surface area by BET method 110 m²/g | | |
| pH: 9.3 | | |
| Tap density: 0.98 | | |
| Surface treatment agent: Al₂O₃, Y₂O₃ | | |
| Carbon black (manufactured by Mitsubishi Chemical Corporation) | 20 | parts |
| Average primary particle size: 16 nm | | |
| DBP oil absorption: 80 ml/100 g | | |
| pH: 8.0 | | |
| Specific surface area by BET method 250 m²/g | | |
| Volatiles: 1.5% | | |
| Vinyl chloride copolymer | 12 | parts |
| MR-110 manufactured by ZEON Corporation | | |
| Polyester-polyurethane resin | 12 | parts |
| UR-8200 manufactured by Toyobo | | |
| Stearic acid | 2 | parts |
| Methyl ethyl ketone | 150 | parts |
| Cyclohexanone | 50 | parts |
| Toluene | 50 | parts |

The above described components for forming the upper layer (magnetic layer) or the lower layer (intermediate layer) were kneaded in a kneader and then dispersed using a sand-mill. To the resulting dispersion for the upper layer, was added 1.6 parts by weight of secondary butyl stearate (sec-BS). To the resulting dispersion for the lower layer, was added 3 parts of the above described polyisocyanate (trade name: Coronate L, manufactured by Nippon Polyurethane Industry Co., Ltd.). Further, to each of these dispersions, were added 40 parts of a mixed solution of methyl ethyl ketone and cyclohexanone. Each of the resulting mixtures was filtered with a filter having an average pore size of 1 μm to prepare a coating solution for forming the upper layer and a coating solution for forming the lower layer, respectively.

(Components of coating solution for back layer)

| | |
|---|---|
| Fine-grain carbon black | 100 parts |
| Average particle size: 20 nm | |
| Coarse-grain carbon black | 10 parts |
| Average particle size: 270 nm | |
| Nitrocellulose resin | 100 parts |
| Polyester-polyurethane resin | 30 parts |
| Dispersant | |
| Copper oleate | 10 Parts |
| Copper phthalocyanine | 10 parts |
| Barium sulfate (settling) | 5 parts |
| Methyl ethyl ketone | 500 parts |
| Toluene | 500 parts |
| α-Alumina | 0.5 parts |
| Average particle size: 0.13 μm | |

The above described components were kneaded in a continuous kneader and then dispersed using a sand-mill for two hours. To the resulting dispersion, were added 40 parts of the polyisocyanate (trade name: Coronate L, manufactured by Nippon Polyurethane Industry Co., Ltd.) and 1,000 parts of methyl ethyl ketone. The resulting mixture was filtered with a filter having an average pore size of 1 μm to prepare a coating solution for forming the back layer.

(Method for Manufacturing Magnetic Tape (Examples 1 to 4, Comparative Examples 1 to 4))

A non-magnetic substrate made of PEN (polyethylene naphthalate) having a thickness of 6 μm (Tg: 120° C.) was heat-treated in a heat-treatment chamber at 110° C. for one day. After the heat treatment, the substrate was cooled to room temperature. Subsequently, the coating solution for forming the upper layer and the coating solution for forming the lower layer were coated on the above substrate by a simultaneous multilayer coating method so that the lower layer (intermediate layer) has a thickness of 1.3 μm after drying and the magnetic layer has a thickness of 0.2 μm after drying on the intermediate layer.

Then, while these layers are still in a wet state, they were subjected to orientation treatment by using a cobalt magnet having a magnetic flux density of 3,000 gauss and a solenoid having a magnetic flux density of 1,500 gauss. Subsequently, these layers were dried at a temperature not higher than the Tg of the substrate to form the non-magnetic intermediate layer and the magnetic layer.

Subsequently, the above coating solution for forming the back layer was coated on the other side of the substrate so that the back layer has a thickness of 0.5 μm after drying and dried at a temperature not higher than the Tg of the substrate to form the back layer. Thus, a magnetic recording laminate roll was obtained in which the lower layer (intermediate layer) and the magnetic layer are provided on one surface of the substrate and the back layer are provided on the other surface of the substrate.

The thus obtained magnetic recording laminate roll was subjected to calender treatment by passing the same through a seven-step calendering machine (at a temperature of 90° C. and a speed of 300 m/min) composed of heated metal rollers and elastic rollers with a thermosetting resin covering on a metal core. Then, the magnetic recording laminate roll after calender treatment was slitted to a width of 12.7 mm (0.5 inches) to obtain a magnetic tape, which was used as the sample in Example 1.

### Example 2

A magnetic tape was prepared in the same manner as in Example 1 except that the substrate was heat-treated at 115° C. for two days.

### Example 3

A magnetic tape was prepared in the same manner as in Example 1 except that the substrate was heat-treated at 110° C. for four days.

### Example 4

A magnetic tape was prepared in the same manner as in Example 1 except that the substrate was heat-treated at 90° C. for seven days.

### Comparative Example 1

A magnetic tape was prepared in the same manner as in Example 1 except that the substrate was not heat-treated.

### Comparative Example 2

A magnetic tape was prepared in the same manner as in Example 1 except that the substrate was heat-treated at 60° C. for four days.

### Comparative Example 3

A magnetic tape was prepared in the same manner as in Example 1 except that the substrate was heat-treated at 65° C. for four days.

### Comparative Example 4

A magnetic tape was prepared in the same manner as in Example 1 except that the coating films were dried at a temperature exceeding the Tg of the substrate.

(Evaluation 1: Measurement of Loss Modulus E₂)

A sample of 10 mm in length and 3.35 mm in width was cut from the magnetic tape in the longitudinal direction, and it was used as a magnetic tape sample. Then, the upper and lower layers and the back layer were removed from the magnetic tape using a solvent to separate the substrate. A sample of 110 mm in length and 3.35 mm in width was cut from the substrate in the longitudinal direction, and it was used as a sample for measurement.

The loss modulus E₂ in the dynamic viscoelasticity measurement at a frequency of 0.5 Hz was measured at a temperature between 15° C. and 200° C. using the dynamic viscoelasticity measurement apparatus (type: DMS6100) manufactured by Seiko Instruments Inc. connected to the measuring station (type: EXSTAR6000) manufactured by the same company, and the loss modulus E₂ at 130° C. was read.

(Evaluation 2: Measurement of Creep Deformation)

A sample of 15 mm in length and 5 mm in width was cut from the magnetic tape in the longitudinal direction. Creep deformations were measured by use of the tester (type: TM-9300) manufactured by ULVAC-RIKO, Inc. at a measuring temperature of 50° C. In the first step, was given a stress of 0.6 MPa for 30 minutes, and in the second step, was given a stress of 15.7 MPa for 50 hours. The sample length after loading a stress of 15.7 MPa was defined as the initial sample length, and elongation (percentage) of the sample after a lapse of 50 hours in the second step was determined, and it was defined as the creep value. The creep value of 0.10% or less was determined to be good.

(Evaluation Results of Examples and Comparative Examples)

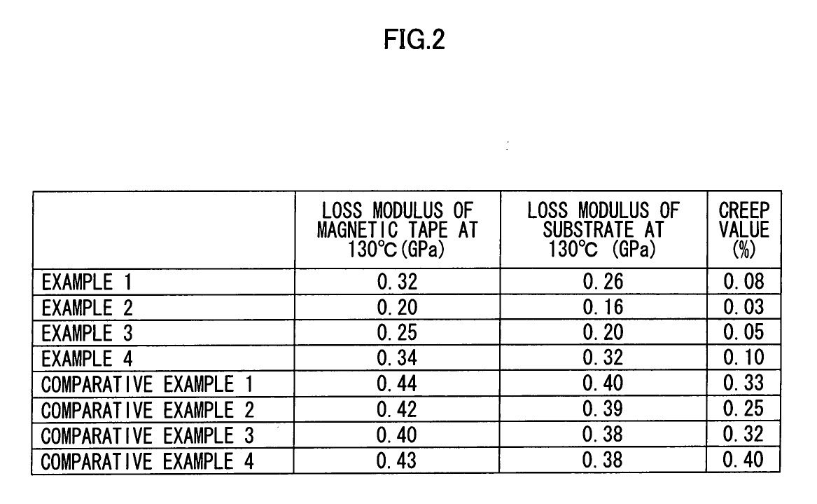

Evaluation results of Examples 1 to 4 and Comparative Examples 1 to 4 were summarized in the table of FIG. 2.

The magnetic tapes (magnetic recording media 10) in Examples 1 to 4 had a loss modulus E₂ of 0.20 to 0.34 GPa, and the substrates 12 in Examples 1 to 4 had a loss modulus E₂ of 0.16 to 0.32 GPa. In addition, the creep deformation value was in the range of 0.03 to 0.10%, all showing good results.

On the other hand, the magnetic tapes (magnetic recording media 10) in Comparative Examples 1 to 4 had a loss modulus E₂ of 0.40 to 0.44 GPa, and the substrates 12 in Comparative Examples 1 to 4 had a loss modulus E₂ of 0.38 to 0.40 GPa. In addition, the creep deformation value was in the range of 0.25 to 0.40%, all showing poor results.

It was verified from the above results that the present invention improves the dimensional stability of a tape, and as a result, it is possible to improve reliability in recording and reproduction of data.

What is claimed is:

1. A magnetic recording medium comprising:
a non-magnetic substrate; and
one or more magnetic layers formed on the non-magnetic substrate, wherein
the magnetic recording medium has a loss modulus at 0.5 Hz at a temperature of 130° C. of 0.18 to 0.39 GPa.

2. A magnetic recording medium comprising:
a non-magnetic substrate; and
one or more magnetic layers formed on the non-magnetic substrate, wherein
the non-magnetic substrate is composed of polyethylene naphthalate and has a loss modulus at 0.5 Hz at a temperature of 130° C. of 0.15 to 0.37 GPa.

3. The magnetic recording medium according to claim 1, further comprising a magnetic or non-magnetic intermediate layer between the non-magnetic substrate and the magnetic layer.

4. The magnetic recording medium according to claim 2, further comprising a magnetic or non-magnetic intermediate layer between the non-magnetic substrate and the magnetic layer.

5. A method for manufacturing a magnetic recording medium comprising the step of:
forming one or more magnetic layers and/or non-magnetic layers on a non-magnetic substrate, wherein
the non-magnetic substrate is subjected to heat treatment at temperatures 1 to 25° C. lower than the glass transition temperature Tg of the substrate before forming the magnetic layers and/or the non-magnetic layers; and
the heat treatment temperatures for the substrate in a manufacturing step after the heat treatment are maintained at temperatures lower than the glass transition temperature Tg of the substrate.
